(19) United States
(12) Patent Application Publication
(10) Pub. No.: US 2024/0308795 A1
(43) Pub. Date: Sep. 19, 2024

(54) MODULAR CONTAINER LOADING RAMP

(71) Applicant: Williams Scotsman, Inc., Baltimore, MD (US)

(72) Inventors: Jodi Shaw, Tempe, AZ (US); Gregg Sheddy, Shrewsbury, PA (US); Corey Salemi, Baltimore, MD (US); Donald G. Everard, Gallatin, TN (US); Judson S. Branch, Nashville, TN (US); Ronald S. Winter, Pacific, WA (US)

(21) Appl. No.: 18/603,912

(22) Filed: Mar. 13, 2024

Related U.S. Application Data
(60) Provisional application No. 63/489,925, filed on Mar. 13, 2023.

(51) Int. Cl. B65G 69/30

(52) U.S. Cl. CPC B65G 69/30

(57) ABSTRACT

A modular loading ramp system includes an entry portion configured for contact with the ground, a planar section providing the primary load-carrying portion of the ramp, and a raised-surface-engaging portion for engagement with the threshold of a container, such as a metal storage container or a mobile office. The entry portion has a generally flat top surface that provides smooth transition to the planar section, and an angled lower face that defines the angle that the ramp may assume when deployed, which angle limits the ramp incline during use to no greater than approximately 10%. The raised-surface-engaging portion defines a curved surface configured to engage the container through a line contact to improve stability. Connecting members are provided along opposite side edges of each ramp unit and are configured to mate with connecting members on an opposite edge of an identical ramp unit, thus enabling a modular assembly of multiple ramp units to adapt to varied container entrance configurations.

### CROSS REFERENCE TO RELATED APPLICATIONS

This application claims the benefit of U.S. Provisional Patent Application No. 63/489,925 titled “CONTAINER RAMP,” filed by the Applicant herein on Mar. 13, 2023, the specification of which is incorporated herein by reference in its entirety.

### FIELD OF THE INVENTION

The present invention relates to loading ramps, and more particularly to a modular, portable ramp system designed for use with storage containers, shipping containers, and mobile offices to facilitate the safe and efficient loading and unloading of goods.

### BACKGROUND OF THE INVENTION

Loading ramps are used in a wide variety of industries to aid the loading and unloading of articles between different levels, including in the context of loading and unloading goods to and from storage containers, shipping containers, and mobile offices. Traditional ramps are designed to provide a sloped surface that facilitates the movement of cargo, equipment, and personnel. However, these ramps may often present challenges in terms of safety, compatibility with various container designs, and practicality in terms of transportation and storage.

One of the primary concerns with existing ramp solutions is safety. Steep inclines can lead to increased risk of accidents, such as shifting or falling loads, which not only endanger personnel but also risk damaging the cargo and equipment. Additionally, transitions between the ramp and the ground or container threshold can create tripping hazards or cause rolling equipment to become unstable. These issues underscore the need for a ramp design that prioritizes a gentle slope and seamless transitions to enhance user safety.

Compatibility with a wide range of container sizes and threshold heights is another significant issue. Many ramps are built to a fixed width and cannot be adjusted to fit the varying dimensions of container doorways. This limitation can result in gaps or overhangs that compromise the stability of the ramp and the safety of its users. Furthermore, fixed-size ramps may not be suitable for use with containers that have damaged or uneven thresholds, leading to misalignment and instability.

Finally, the practical aspects of ramp use, such as ease of transportation, storage, and deployment, are often overlooked in conventional designs. Ramps that are heavy or cumbersome can be difficult to move and position, requiring multiple personnel or specialized equipment. This not only increases the time and labor required to set up the ramp, but also presents additional safety risks during handling. Thus, there remains a clear need in the art for a ramp system that is lightweight, portable, and easy to assemble and install, while still being robust enough to handle the demands of industrial and commercial use.

### SUMMARY OF THE INVENTION

The present invention addresses at least some of the foregoing concerns by providing a modular ramp system that is safe, compatible with a variety of container designs, and user-friendly in terms of transport and deployment. The innovative features of this system provide significant improvements over traditional ramp solutions, making it a valuable asset in the field of logistics and material handling.

In accordance with certain aspects of an embodiment, a modular ramp is provided for use on large containers, such as storage containers, shipping containers, mobile offices, and the like. It is intended for use with these structures to allow a ramped entry, which in turn will aid in loading equipment and heavy items into the container or mobile office. It is modular to enable deployment in varying widths to accommodate container and mobile office openings of varying sizes.

An exemplary ramp includes a planar section, an entry portion at one end of the planar section, and a raised-platform-engaging portion at the opposite end of the planar section, the raised-platform-engaging portion configured for engaging a threshold or other raised surface at the entrance of a container. In an exemplary configuration, the bottom face of the entry portion angles upward (e.g., at an angle of 5-7 degrees to maintain a maximum ramp slope of not more than approximately a 10% slope), and the angle formed between the bottom face of the entry portion and the ground defines the angle to which the planar section may be rotated upward to allow engagement of the raised-platform-engaging portion with a raised platform, such as the threshold at the entrance of a storage or shipping container or the entrance to a mobile office. The raised-platform-engaging portion has a single downwardly curving arm that curves downward from the end of the top face of the planar section and is configured to establish a line contact with that raised platform on the container or mobile office. This decreased area of line contact improves stability over previously known portable ramp constructions, thus making the ramp less prone to misalignment or other adverse effects caused by debris on or damaged surfaces of the threshold. This configuration also allows placement of the raised-platform-engaging portion on raised surfaces of varying heights by simply changing the lateral position of the full ramp with respect to the raised platform, and without requiring that the angle of the top face of the planar section change.

Further, in an exemplary configuration, one side edge of the ramp has one or more connecting members configured for interconnecting multiple modular ramp sections or units, thus enabling adaptability of the ramp to container entries of varying widths. For example, pins may extend outward from the side edge, configured to engage with recesses on the opposite side edge, such that two or more identical ramp units may be brought together in a side-by side arrangement and slid together so that the pins of one ramp unit engage the recesses of the other ramp unit, thus expanding the width of the resulting ramp. Further, curved bulbs may extend outward from the side edge, configured to engage with mating curved sockets on the opposite edge, such that again two or more identical ramp units may be brought together in a side-by-side arrangement. Ramp units with this configuration may be joined together by having the second placed ramp section pivot downward from an angle of approximately 35° to 45° to parallel with the first placed ramp section and, in turn, sliding the bulbs into their mating sockets to expand the width of the resulting ramp. Even further, one side of the panel may be configured with a first portion of a tongue and groove joint, configured to engage with a mating second portion of a tongue and groove joint on the opposite side edge of the ramp unit, such that yet again two or more identical ramp units may be brought together in a side-by-side arrangement. Ramp units with this configuration may be joined together by positioning the bottom portion of a new ramp unit adjacent to the bottom portion of an adjacent, already placed ramp unit and pivoting the new ramp unit downward to engage the mating portions of the tongue and groove joint.

Such a modular configuration provided by these interconnecting ramp unit components allows use of smaller ramp units, and thus the manual manipulation of less weight, in those scenarios where a wider ramp is not required, but while still allowing a wider surface to be used by joining together multiple ramp units when a wide ramp surface is required. This configuration facilitates easy assembly and disassembly by a single person, reducing the potential for injury and damage during handling.

A modular container loading ramp configured in accordance with at least certain aspects of the invention may provide multiple advantages over previously known portable ramps. First, this configuration ensures that the ramp assumes no greater than approximately a 10% slope, which low slope reduces chances of injury and/or damage due to shifting or falling loads as they are transported across the ramp. Such a minimal slope also requires less physical strain or exertion in carrying loads into the storage or shipping container or mobile office that could result in personal injury, particularly in comparison to more steeply inclined ramps. This risk is particularly present during the use of loaded hand trucks or pallet jacks. Further, the minimal slope provides a smooth transition both on to and off of the ramp, providing less likelihood of injury. Still further, the minimal slope reduces the likelihood of a non-rolling part of a pallet jack inadvertently contacting an obstructive surface on the ramp and stopping abruptly, thus again reducing the chance of personal injury. The length of the ramp is selected to generally provide such a minimal slope while being able to accommodate a sufficient rise, such as for example up to 7 inches, which is the maximum height of common thresholds of metal storage containers and mobile offices.

Moreover, the foregoing configuration will provide a structure enabling attachment of two or more ramp sections to create a platform having multiple width options. Particularly, the mating connecting members on opposite sides of the ramp units facilitate easy assembly and disassembly by a single person, reducing potential for injury and damage during handling.

Further, the raised-platform-engaging portion that joins to the container or mobile office entry is configured to enable connection through lateral motion only, eliminating the need for lifting during the connection process and reducing the risk of pinching or other injuries. Likewise, as the raised-platform-engaging portion is further configured to engage the container or mobile office entrance by line contact, this configuration enhances stability and accommodates for debris or damage on the threshold of the entry. The arched configuration of the raised-platform-engaging portion even further allows extension of the exit end of the ramp beyond the outer edge of the threshold, allowing the ramp to be compatible with multiple styles and configurations of containers.

In accordance with aspects of an embodiment of the invention, a modular ramp system for facilitating the loading and unloading of containers and mobile offices is provided, comprising a planar section; an entry portion affixed to a first end of the planar section, the entry portion having an angled bottom face; a raised-platform-engaging portion affixed to a second end of the planar section opposite the first end of the planar section, the raised-platform-engaging portion forming a downwardly curving arm; wherein the planar section, the entry portion, and the raised-platform-engaging portion together form a first ramp unit; a first connecting member on a first side edge of the first ramp unit; and a second connecting member on a second side edge of the first ramp unit opposite the first side edge of the first ramp unit, wherein each of the first connecting member and the second connecting member have complementary shapes configured for interlocking engagement with another of the second connecting member and the first connecting member, respectively, on a second ramp unit of identical construction to the first ramp unit.

The entry portion may have an entry portion top face having an entry portion top face planar portion that is co-planar with a planar section top face of the planar section, and the entry portion may define a downward curve at an end of the entry portion opposite the planar section. The entry portion angled bottom face may further comprise a planar section that extends upward from a planar section bottom face of the planar section to the end of the entry portion opposite the planar section.

The downwardly curving arm of the raised-platform-engaging portion may further comprise a curved top face and a curved bottom face, wherein the curved top face of the raised-platform-engaging portion has a varied radius of curvature that increases towards an end of the curved top face opposite the planar section. The curved bottom face may be configured to form a line contact with a threshold of a container or mobile office. Further, an end of the downwardly curving arm may terminate at a vertical position that is higher than a planar section bottom face of the planar section.

The first connecting member may further comprise a pin extending outward from the first side edge of the first ramp unit, and the second connecting member may further comprise a recess extending into the second side edge of the first ramp unit and aligned with the pin. Likewise, the first connecting member may further comprise an upwardly curving socket extending along the first side edge of the first ramp unit, and the second connecting member may further comprise an upwardly curving bulb extending outward from the second side edge of the first ramp unit and having a mating shape to said upwardly curving bulb.

Further, the first connecting members may further comprise a first portion of a tongue and groove joint along the first side edge of the first ramp unit, and the second connecting member may further comprise a second portion of the tongue and groove joint along the second side edge of the first ramp unit and having a mating shape to said first portion of the tongue and groove joint.

A second ramp unit identical in construction to the first ramp unit may be positioned adjacent to the first ramp unit, wherein the first connecting members of the first ramp unit engage the second connecting members of the second ramp unit.

The ramp unit may further comprise one or more carry handles affixed to the ramp unit to extend outward from one of the first side edge and the second side edge of the ramp unit.

Further, the angled bottom face of the entry portion may define an angle with respect to a planar section bottom face of the planar section of between 5 and 7 degrees.

In accordance with further aspects of an embodiment of the invention, a method for assembling a modular ramp system is provided, comprising the steps of: providing a plurality of ramp units of identical construction, each ramp unit comprising: a planar section; an entry portion affixed to a first end of the planar section, the entry portion having an angled bottom face; a raised-platform-engaging portion affixed to a second end of the planar section opposite the first end of the planar section, the raised-platform-engaging portion forming a downwardly curving arm; a first connecting member on a first side edge of the ramp unit; and a second connecting member on a second side edge of the ramp unit opposite the first side edge of the ramp unit, wherein each of the first connecting member and the second connecting member have complementary shapes configured for interlocking engagement with another of the second connecting member and the first connecting member, respectively, on a second one of the ramp units; aligning the plurality of ramp units side-by-side; and engaging the first connecting member of one of the ramp units with the second connecting member of an adjacent one of the ramp units to form a continuous ramp surface of a width greater than a single one of the plurality of ramp units.

The first connecting member may further comprise a pin extending outward from the first side edge of the first ramp unit, and the second connecting member may further comprise a recess extending into the second side edge of the first ramp unit and aligned with the pin, and the step of engaging the connecting members may further comprise sliding the pin of said one of said ramp units into the recess of said adjacent one of said ramp units.

The first connecting member may still further comprise an upwardly curving socket extending along the first side edge of the first ramp unit, and the second connecting member may further comprise an upwardly curving bulb extending outward from the second side edge of the second ramp unit and having a mating shape to the upwardly curving socket, and the said step of engaging the connecting members may further comprise positioning a second one of the plurality of ramp units at an angle with respect to a first one of the plurality of ramp units so that side edges of each of the first one and the second one of the plurality of ramp units are adjacent to one another, and pivoting the second one of the plurality of ramp units into a coplanar orientation with the first one of the plurality of ramp units.

The first connecting member may still yet further comprise a first portion of a tongue and groove joint along the first side edge of the first ramp unit, and the second connecting member may further comprise a second portion of the tongue and groove joint along the second side edge of the first ramp unit and having a mating shape to the first portion of the tongue and groove joint, and the step of engaging the connecting members may further comprise positioning a first one of the plurality of ramp units at an incline with respect to a second one of the plurality of ramp units and so that an entry portion of the first one of the plurality of ramp units is adjacent to an entry portion of the second one of the plurality of ramp units, and lowering the first one of the plurality of ramp units into a lower incline angle matching an incline angle of the second one of the plurality of ramp units.

The method may further comprise the step of adjusting the lateral position of the ramp units with respect to a threshold of a container or mobile office to change a vertical point of contact between the plurality of ramp units and the container or mobile office.

The method may further comprise the step of joining the plurality of ramp units to a threshold of a container or mobile office such that an angle of the plurality of the planar sections of the ramp units does not exceed approximately a 10% slope.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a side perspective view of a modular ramp unit according to certain aspects of an embodiment of the invention.

FIG. 2 is a side view of the ramp unit of FIG. 1.

FIG. 3 is a top view of the ramp unit of FIG. 1.

FIG. 4 is a bottom perspective close-up view of a carry handle for use with the ramp unit of FIG. 1.

FIG. 5 is a side perspective view of two modular ramp units of FIG. 1 joined together and positioned at the threshold of a container.

FIG. 6 is a side view of two adjacent ramp units of identical configuration and according to further aspects of an embodiment of the invention being joined together through a side-by-side pivoting movement.

FIG. 7 is a schematic view depicting the interconnecting placement of two ramp units of FIG. 6 in a side-by-side position.

FIG. 8 is a side view of two adjacent ramp units of identical configuration and according to further aspects of an embodiment of the invention being joined together through a longitudinal pivoting movement.

FIG. 9 is a schematic view depicting the interconnecting placement of two ramp units of FIG. 8 in a side-by-side position.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first,” “second,” and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

In accordance with certain aspects of an embodiment of the invention, a container ramp 100 is provided that is configured to ease placement and use of a ramp for loading and unloading of containers 200 (FIG. 5), such as metal shipping containers, modular/portable offices, and similarly configured containers.

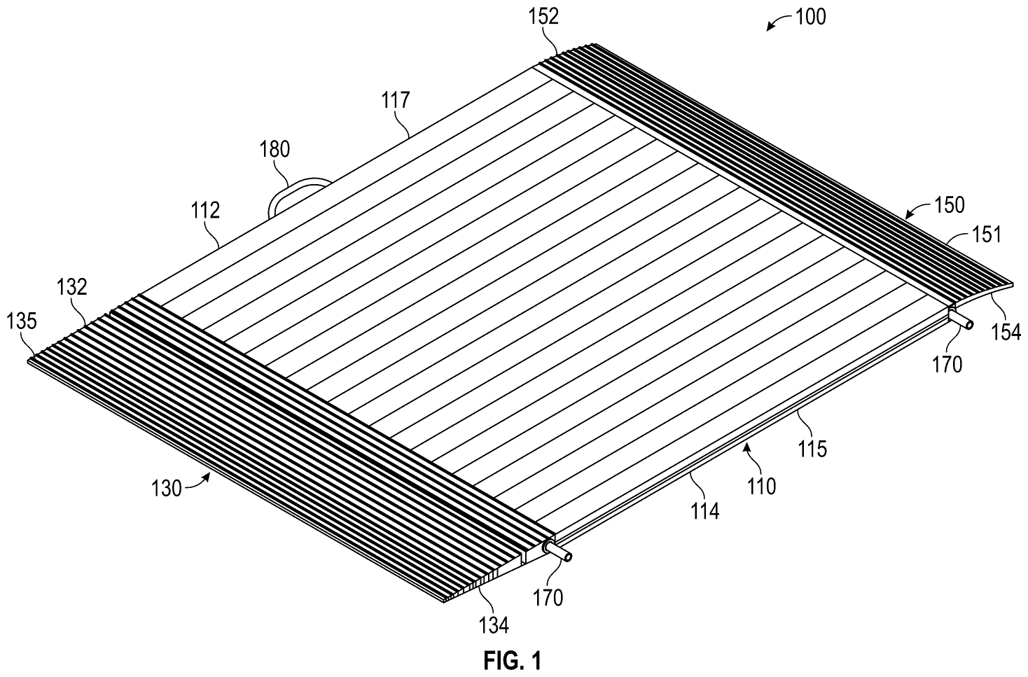

In accordance with certain aspects of an embodiment and with particular reference to FIGS. 1-3, a modular ramp 100 is provided for use on large containers, such as storage containers, shipping containers, mobile offices, and the like. It is intended for use with these structures to allow a ramped entry, which in turn will aid in loading equipment and heavy items into the container or mobile office. It is modular to enable deployment in varying widths to accommodate container and mobile office openings of varying sizes.

An exemplary ramp 100 includes a planar section 110, an entry portion 130 at one end of the planar section 110, and a raised-platform-engaging portion 150 at the opposite end of the planar section 110, the raised-platform-engaging portion 150 configured for engaging a threshold or other raised surface at the entrance of a container. Entry portion 130 and the raised-platform-engaging portion 150 may each be formed unitarily with the planar section 110 or may alternatively be formed as separate elements and thereafter joined to the ends of the planar section 110.

In an exemplary configuration, entry portion 130 has a top face 132 and a bottom face 134. The majority of the top face 132 is aligned with the top face 112 of the planar section 110 so that there is easy transition between the entry portion 130 and the planar section 110, which will not interfere with rollers on a cart or create other hazards as a person starts travel onto the ramp 100. The free end of entry portion 130 may have a slight downward turn 135 at the very end (i.e., the entry end of the ramp 100), facilitating a smooth transition from the ground on to ramp 100. The bottom face 134 of the entry portion 130 angles upward from the end of the bottom face 114 of the planar section 110 and extends upward toward the free end to the top face 132 of the entry portion 130. Thus, the entry portion 130 is generally in the form of a triangle having a top face 132 that is largely aligned with the top face 112 of the planar section 110, a bottom face 134 that is angled upward from the bottom face 114 of the planar section 110, and a rear face that coincides with a side edge of the planar section 110. The angle ß formed between the bottom face 134 of the entry portion 130 and the ground defines the angle to which the planar section 110 may be rotated upward to allow engagement of the raised-platform-engaging portion 150 with a raised platform, such as the threshold 210 at the entrance of a storage or shipping container 200 (FIG. 5) or the entrance to a mobile office. In a particularly preferred embodiment, the angle formed between the bottom face 134 of the entry portion 130 and the ground may be approximately 5 to 7 degrees, such that the top face 112 of the planar section 110 may assume an upward angle of 5 to 7 degrees when in use as an entry into a storage or shipping container or mobile office. Entry portion 130 is preferably formed of a material that is durable and capable of withstanding the weight and forces exerted during the loading and unloading of equipment, such as aluminum or steel, which materials offer a good balance of strength, durability, and weight. More particularly, entry portion 130 may, in exemplary configurations, be formed of materials selected to ensure durability, strength, and longevity, while accounting for the desires for manageable weight and corrosion resistance, such as aluminum, high-strength steel, stainless steel, and alloy composites (e.g., fiberglass-reinforced plastics or carbon fiber composites).

The raised-platform-engaging portion 150 has a single downwardly curving arm 151 that curves downward from the end of the top face of the planar section 110, and that provides the raised-platform-engaging portion 150 a curved top face 152 and a curved bottom face 154. When the planar section 110 of the panel 100 is rotated upward to engage with the raised surface of a storage or shipping container or a mobile office (such as the threshold 210 at the entrance of the container or mobile office), the curved bottom face 154 of the raised-platform-engaging portion 150 will establish a line contact with that raised surface. In other words, the curved bottom face 154 of the raised-platform-engaging portion 150 contacts the threshold or other surface of the storage or shipping container or mobile office along a single line across the full width of the ramp 100. This decreased area of contact between ramp 100 and container threshold 210 improves stability and minimizes rocking or shifting, thus making the ramp less prone to misalignment or other adverse effects caused by debris on or damaged surfaces of the threshold. This configuration allows placement of the raised-platform-engaging portion 150 on raised surfaces of varying heights, with the length of raised-platform-engaging portion 150 extending beyond the outermost edge of the container threshold, by simply changing the lateral position of the full ramp 100 with respect to the raised surface or threshold, and without requiring that the angle of the top face 112 of the planar section 110 change from, e.g., 5-7 degrees (or such other angle as exists between the bottom face of the entry portion and the ground).

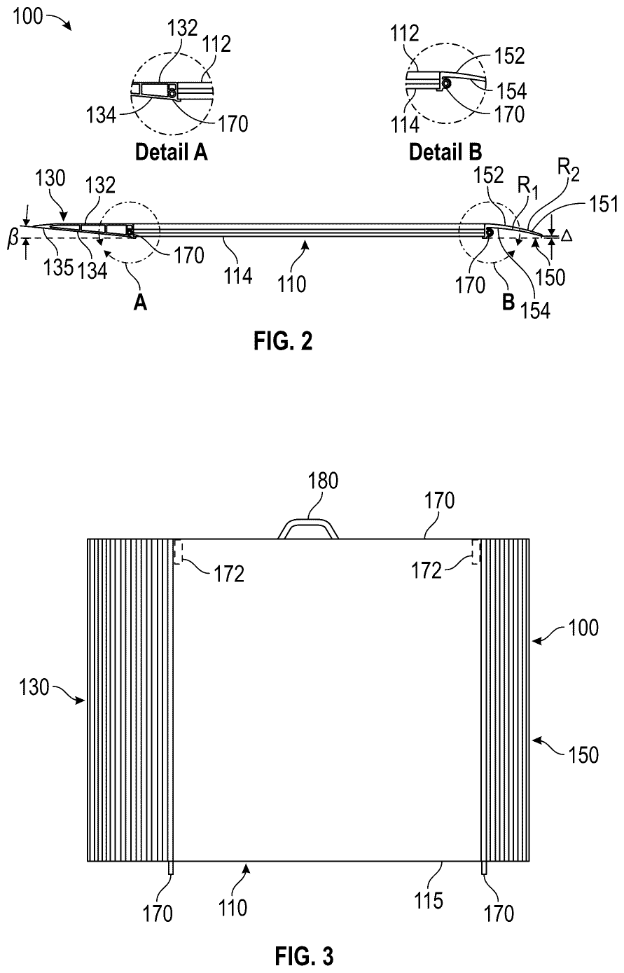

Raised-platform-engaging portion 150, configured as described here, allows quick and easy attachment of ramp 100 to a storage container or mobile office entry, facilitating easy setup and removal without requiring excessive force or specialized tools. As best shown in FIG. 2, raised-platform-engaging portion 150 has a radius of curvature that increases (e.g., from R1 to R2 in FIG. 2) towards the outermost edge of raised platform engaging portion 150. Likewise, the bottom of the outermost edge of raised-platform-engaging portion 150 preferably ends at a distance A that is slightly above the plane of bottom face 114 of planar section 110 to ensure that raised platform engaging portion 150 does not contact or get damaged by the ground when ramp 100 is stored flat on the ground. Likewise, such configuration ensures that ramp 100 does not damage the container threshold during use. Raised-platform-engaging portion 150 is preferably formed of a material that is durable and capable of withstanding the weight and forces exerted during the loading and unloading of equipment, such as aluminum or steel, which materials offer a good balance of strength, durability, and weight. More particularly, raised platform engaging portion 150 may, in exemplary configurations, be formed of materials selected to ensure durability, strength, and longevity, while accounting for the desires for manageable weight and corrosion resistance, such as aluminum, high-strength steel, stainless steel, and alloy composites (e.g., fiberglass-reinforced plastics or carbon fiber composites).

In accordance with certain aspects of an embodiment, side edges of ramp 100 may include connecting members for connecting adjacent units of ramp 100 to one another in an interlocking, side-by-side arrangement. In one exemplary configuration, one side edge 115 of the ramp 100 may have at least two connecting members 170, such as pins extending outward from the side edge 115, preferably located on aligned sides of each of the entry portion 130 and the raised-platform-engaging portion 150 adjacent to where each of those respective portions connect to the planar section 110. Connecting members 170 are formed from materials and of a dimension capable of withstanding the weight and forces associated with loading and unloading of containers and mobile offices, which materials may readily be selected by persons of ordinary skill in the art. By way of non-limiting example, such materials may comprise steel and/or aluminum, each of which offers strength and corrosion resistance. More particularly, in exemplary configurations, connecting members 170 may be formed of hardened steel, stainless steel, anodized aluminum, brass, or bronze, with the specific material being readily selectable by a person skilled in the art to meet a particular application's requirements for durability, resistance to deformation, weight, surface hardness, corrosion resistance, friction, and the like. Likewise, in exemplary configurations, connecting member 170 may have a diameter of, for example, approximately 0.5 inches, and may extend outward from the side edge 115 of ramp 100 by, for example, approximately 1.5 inches. Likewise, recesses 172 (shown in phantom in FIG. 3) are provided on the opposite side edge of the ramp in alignment with the connecting members 170. In this configuration, two identical ramp units 100 configured as above may be brought together and interconnected in a side-by side arrangement and slid together so that the connecting members 170 of one ramp unit engage the recesses 172 of the other ramp unit, thus expanding the width of the resulting ramp 100. This modular configuration allows use of smaller ramp units 100, and thus the manual manipulation of less weight, in those scenarios where a wider ramp is not required, but while still allowing a wider surface to be used by joining together multiple ramp units 100 when a wide ramp surface is required. This configuration facilitates easy assembly and disassembly by a single person without the need for additional tools or complex assembly processes, reducing the potential for injury and damage during handling.

FIG. 5 shows two ramp units 100 positioned adjacent to one another at the threshold 210 of a container 200, such as a shipping container, with raised-platform-engaging portion 150 engaging the threshold 210 along a single line contact. Two ramp units 100 are shown, positioned immediately adjacent to and in contact with one another, such that the connecting members on one side edge of a first one of the ramp units 100(a) enter into the recesses on the opposite side edge of the second one of the ramp units 100(b) to provide a secure interconnection between the ramp units 100(a) and 100(b).

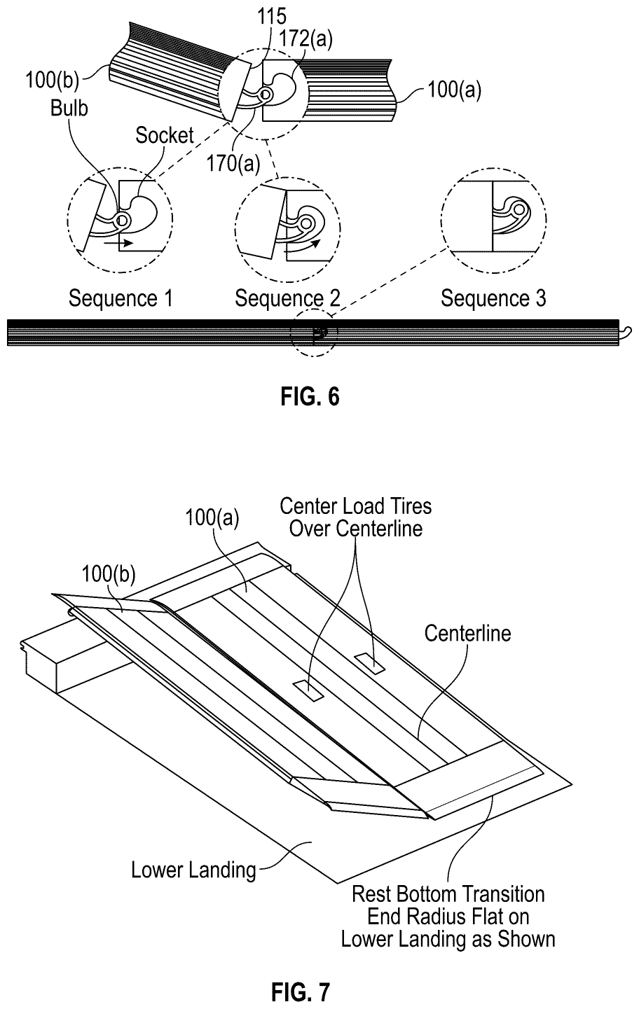

With reference to FIGS. 6 and 7 and in accordance with further aspects of an embodiment, one side edge 115 of the ramp 100 may have one or more connecting members 170(a), such as one or more slide bulbs that may extend along a length of, and in a particularly preferred configuration along a majority of the length of, side edge 115 of ramp 100. Connecting members 170(a) may be formed of like materials to those described above for connecting members 170. Likewise, recesses 172(a), such as one or more sockets, may extend along the opposite side edge of ramp 100 in alignment with connecting member(s) 170(a). In this configuration, two identical ramp units 100 configured as above may be brought together and interconnected in a side-by-side arrangement by first positioning a first ramp unit 100(a) at the threshold, and then positioning a second ramp unit 100(b) at approximately a 35° to 45° angle to first ramp unit 100(a) to insert slide bulb 170(a) of second ramp unit 100(a) into socket 172(a) of first ramp unit 100(b), thus again expanding the width of the resulting ramp 100. Such a configuration for connecting members 170(a) may provide multiple advantages, including one or more of: (i) enabling easy setup with single person placement and installation without hardware; (ii) ensuring a secure connection between adjacent ramp units; (iii) distributing and sharing loading among multiple ramp units, providing a stronger ramp overall, and (iv) providing a generally easy disassembly and storage.

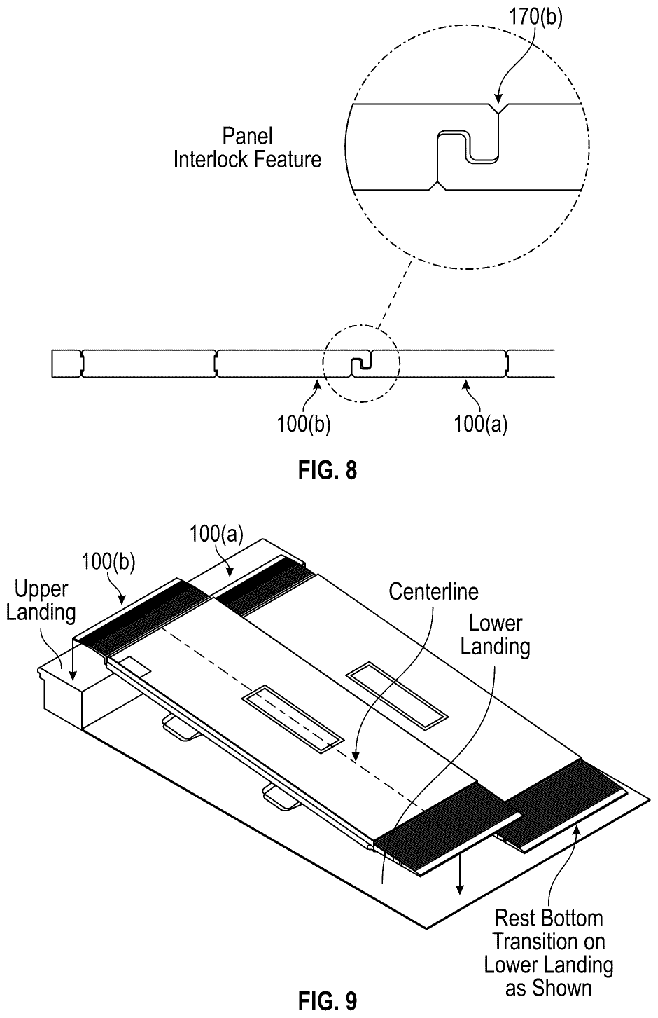

Next and with reference to FIGS. 8 and 9, and in accordance with still further aspects of an embodiment, each side edge of ramp 100 may have one of two mating and interlocking portions of a tongue and groove joint 170(b) extending along preferably a majority of the length of each side edge of ramp 100. Each portion of tongue and groove joint 170(b) may again be formed of like materials to those described above for connecting members 170. In this configuration, two identical ramp units 100 configured as above may be brought together and interconnected in a side-by-side arrangement by first positioning a first ramp unit 100(a) at the threshold, and then positioning a second ramp unit 100(b) so that the bottom entry portions 130 are adjacent to one another with the second ramp unit 100(b) at a steeper incline angle compared to first ramp unit 100(a), and the second ramp unit 100(b) is then rotated downward to interlock mating portions of joint 170(b) between first ramp unit 100(a) and second ramp unit 100(b), thus again expanding the width of the resulting ramp 100.

Providing multiple, e.g., three, ramp units having any of the foregoing connecting members will offer an improved ramp that offers: (i) a low slope to provide improved safety; (ii) a low weight of each ramp unit (each having a weight of approximately 50 lbs. or less); (iii) a high payload capacity (e.g., a capacity of preferably at least 5000 lbs.); and (iv) customization to selectively provide a wide ramp (preferably having a total width when three ramp units are joined that is greater than a standard pallet width) to prevent large loads from tipping over when traversing the ramp.

Planar section 110 provides the primary flat surface of ramp 100 where the load is primarily supported during use, and is preferably formed of a durable, lightweight material, such as aluminum or reinforced composites. In a particularly preferred embodiment, the planar section 110 may have a length of, for example, 50 to 60 inches, and more particularly approximately 51 inches, and the ramp 100 may have a total length (including both the entry portion 130 and the raised-platform-engaging portion 150) of, for example, 60 to 70 inches, and more particularly approximately 66 inches, although shorter or longer spans may be used without departing from the spirit and scope of the invention. Likewise, each ramp unit 100 preferably may have a width (i.e., from side to side of the ramp 100) of, for example, approximately 19 to 20 inches. In general, the total length of ramp 100 should be such that, in use, ramp 100 provides a slope of 10% slope or less. In an exemplary configuration, top face 112 of planar section 110 may include a high traction surface to provide grip and prevent slipping, such as a non-skid or tread pattern or grit surface, a rubber or textured metal surface, or the like to ensure safety during use.

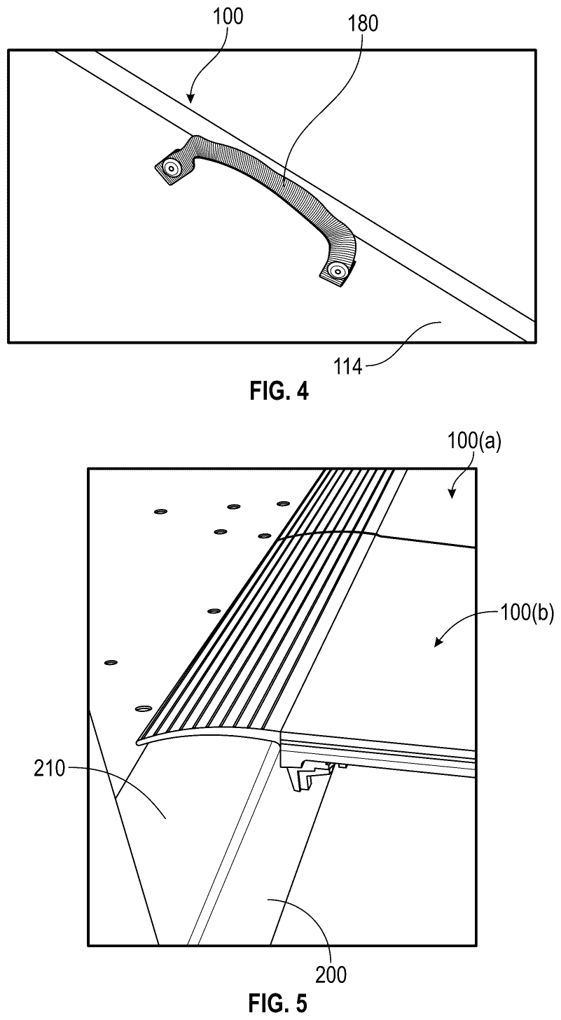

As best viewed in FIG. 4, one or more carry handles 180 may likewise be provided and riveted, bolted, or otherwise fastened to, for example, the bottom face 114 of the planar section 110 of the ramp 100, with a loop portion of the handle 180 extending outward from the side of the ramp 100. Carry handles 180 are attached to the bottom face 114 of planar section 110 adjacent and near to the edge 117 of planar section 110 so that carry handle 180 does not interfere with the ramp's operation while providing a comfortable grip for carrying. Carry handle 180 should also be positioned on planar section 110 to balance the sections of ramp 100 during use. This allows easy grasping of the handle and easy transportation and repositioning of the ramp 100 from place to place as desired. Carry handles 180 are formed of a material that is strong, durable, and capable of withstanding the weight of ramp units 100 and the stress of repeated use. In an exemplary configuration, carry handle 180 may be formed, by way of non-limiting example, of heavy-duty nylon, polyester webbing, or reinforced rubber. Carry handles 180 may optionally include padding, a contoured shape, or other ergonomic features adapted to reduce hand fatigue and to improve grip during transport of ramp unit 100.

A modular ramp system configured in accordance with at least certain aspects of the foregoing may provide multiple advantages over current portable ramps. For example, a modular ramp system according to the above offers a versatile ramp that may be adjusted in width and easily moved through lateral adjustment to reach varying heights to accommodate varied sizes and configurations of container and mobile office openings and entrances, making it suitable for a variety of applications. Likewise, such a modular ramp system provides a low slope and an aligned entry portion and planar section span that offer a smooth transition, thus reducing the risk of accidents and making it easier to load and unload equipment. Overall, a ramp configured in accordance with aspects of the foregoing description will ensure that the load is evenly distributed across the surface, reducing the risk of localized stress and potential deformation or failure. Further, the low slope configuration of the ramp (i.e., providing a slope of no more than 10%) ensures a safe loading process, minimizing the risk of injury and damage due to shifting or falling loads. The long span and low slope offer an ergonomic design that requires less physical strain or exertion when loading or unloading the container or mobile office, which is particularly beneficial when using loaded hand trucks or pallet jacks. Still further, the raised-platform-engaging portion offers a single line contact with the container threshold, which improves stability and is less prone to misalignment or adverse effect from debris or damaged surfaces. Moreover, the carry handles and a manageable weight made possible through a modular, interconnecting design facilitate easy transportation and repositioning. Even further, the configuration of connecting members on opposite sides of each ramp unit allows for quick and secure connection of multiple ramp sections without the need for additional tools or complex assembly processes.

A modular ramp system, configured in accordance with aspects of the invention, may thus provide a low-slope, modular solution that can be easily adapted to various container and mobile office types and sizes, while being manageable by a single individual.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. For example, protective coatings may be applied to one or more portions of ramp 100, such as powder coating, galvanization, anodizing, and the like, which may increase the lifespan of metal parts by protecting them from corrosion and wear. Likewise, in applications in which ramp 100 will be regularly used in environments exposed to sunlight, materials that are UV-resistant or coatings that protect against UV degradation may be used to help maintain the integrity of the ramp 100 over time. Still further, for those areas of ramp 100 that contact the container threshold, wear-resistant pads may be provided to reduce wear and risk of damage and further improve stability. It should be understood, therefore, that the invention may be practiced otherwise than as specifically set forth herein.

1. A modular ramp system for facilitating the loading and unloading of containers and mobile offices, comprising:
a planar section;
an entry portion affixed to a first end of the planar section, said entry portion having an angled bottom face;
a raised-platform-engaging portion affixed to a second end of the planar section opposite the first end of the planar section, said raised-platform-engaging portion forming a downwardly curving arm;
wherein said planar section, said entry portion, and said raised-platform-engaging portion together form a first ramp unit;
a first connecting member on a first side edge of the first ramp unit; and
a second connecting member on a second side edge of the first ramp unit opposite the first side edge of the ramp unit, wherein each of said first connecting member and said second connecting member have complementary shapes configured for interlocking engagement with another of said second connecting member and said first connecting member, respectively, on a second ramp unit of identical construction to said first ramp unit.

2. The modular ramp system of claim 1, said entry portion having an entry portion top face, the entry portion top face having an entry portion top face planar portion that is co-planar with a planar section top face of said planar section, and said entry portion defining a downward curve at an end of said entry portion opposite said planar section.

3. The modular ramp system of claim 2, said entry portion angled bottom face further comprising a planar section that extends upward from a planar section bottom face of said planar section to said end of said entry portion opposite said planar section.

4. The modular ramp system of claim 1, wherein said downwardly curving arm of said raised-platform-engaging portion further comprises a curved top face and a curved bottom face.

5. The modular ramp system of claim 4, wherein said curved top face of said raised-platform-engaging portion has a varied radius of curvature that increases towards an end of said curved top face opposite said planar section.

6. The modular ramp system of claim 5, wherein said curved bottom face is configured to form a line contact with a threshold of a container or mobile office.

7. The modular ramp system of claim 4, wherein an end of said downwardly curving arm terminates at a vertical position that is higher than a planar section bottom face of said planar section.

8. The modular ramp system of claim 1, wherein said first connecting member further comprises a pin extending outward from said first side edge of said first ramp unit, and said second connecting member further comprises a recess extending into said second side edge of the first ramp unit and aligned with said pin.

9. The modular ramp system of claim 1, wherein said first connecting member further comprises an upwardly curving socket extending along the first side edge of the first ramp unit, and said second connecting member further comprises an upwardly curving bulb extending outward from the second side edge of the first ramp unit and having a mating shape to said upwardly curving socket.

10. The modular ramp system of claim 1, wherein said first connecting member further comprises a first portion of a tongue and groove joint along said first side edge of said first ramp unit, and said second connecting member further comprises a second portion of said tongue and groove joint along said second side edge of said first ramp unit and having a mating shape to said first portion of said tongue and groove joint.

11. The modular ramp system of claim 1, wherein a second ramp unit is positioned adjacent to said first ramp unit, wherein said first connecting member of said first ramp unit is interlockingly engaged with said second connecting member of said second ramp unit.

12. The modular ramp system of claim 1, further comprising a carry handle affixed to said first ramp unit and extending outward from one of said first side edge and said second side edge of said ramp unit.

13. The modular ramp system of claim 1, wherein said angled bottom face of said entry portion defines an angle with respect to a planar section bottom face of said planar section of between 5 and 7 degrees.

14. A method for assembling a modular ramp system, comprising the steps of:
providing a plurality of ramp units of identical construction, each said ramp unit comprising:
a planar section;
an entry portion affixed to a first end of the planar section, said entry portion having an angled bottom face;
a raised-platform-engaging portion affixed to a second end of the planar section opposite the first end of the planar section, said raised-platform-engaging portion forming a downwardly curving arm;
a first connecting member on a first side edge of the ramp unit; and
a second connecting member on a second side edge of the ramp unit opposite the first side edge of the ramp unit, wherein each of said first connecting member and said second connecting member have complementary shapes configured for interlocking engagement with another of said second connecting member and said first connecting member, respectively, on a second one of said ramp units;
aligning said plurality of ramp units side-by-side; and
engaging said first connecting member of one of said ramp units with said second connecting member of an adjacent one of said ramp units to form a continuous ramp surface of a width greater than a single one of said plurality of ramp units.

15. The method of claim 14, wherein said first connecting member further comprises a pin extending outward from said first side edge of said first ramp unit, and said second connecting member further comprises a recess extending into said second side edge of the first ramp unit and aligned with said pin, and wherein said step of engaging said connecting members further comprises sliding the pin of said one of said ramp units into the recess of said adjacent one of said ramp units.

16. The method of claim 14, wherein said first connecting member further comprises an upwardly curving socket extending along the first side edge of the first ramp unit, and said second connecting member further comprises an upwardly curving bulb extending outward from the second side edge of the second ramp unit and having a mating shape to said upwardly curving socket, and wherein said step of engaging said connecting members further comprises positioning a second one of said plurality of ramp units at an angle with respect to a first one of said plurality of ramp units so that side edges of each of said first one and said second one of said plurality of ramp units are adjacent to one another, and pivoting said second one of said plurality of ramp units into a coplanar orientation with said first one of said plurality of ramp units.

17. The method of claim 14, wherein said first connecting member further comprises a first portion of a tongue and groove joint along said first side edge of said first ramp unit, and said second connecting member further comprises a second portion of said tongue and groove joint along said second side edge of said first ramp unit and having a mating shape to said first portion of said tongue and groove joint, and wherein said step of engaging said connecting members further comprises positioning a first one of said plurality of ramp units at an incline with respect to a second one of said plurality of ramp units and so that an entry portion of the first one of said plurality of ramp units is adjacent to an entry portion of the second one of said plurality of ramp units, and lowering said first one of said plurality of ramp units into a lower incline angle matching an incline angle of said second one of said plurality of ramp units.

18. The method of claim 14, further comprising the step of adjusting the lateral position of the ramp units with respect to a threshold of a container or mobile office to change a vertical point of contact between said plurality of ramp units and said container or mobile office.

19. The method of claim 14, further comprising the step of joining said plurality of ramp units to a threshold of a container or mobile office such that an angle of said planar sections of said plurality of ramp units does not exceed approximately a 10% slope.
